(19) United States
(12) Patent Application Publication
(10) Pub. No.: US 2024/0255283 A1
(43) Pub. Date: Aug. 1, 2024

(54) Wheel Position and Orientation Measurement System

(71) Applicant: Michigan Scientific Corporation, Milford, MI (US)

(72) Inventors: Andrew Cook, Milford, MI (US); Stephan Barthel, Farmington, MI (US); Yannick Christensen, Whitmore Lake, MI (US)

(21) Appl. No.: 18/564,303

(22) PCT Filed: May 31, 2022
(86) PCT No.: PCT/US2022/031657

§ 371 Date: Nov. 27, 2023

Related U.S. Application Data
(60) Provisional application No. 63/194,423, filed on May 28, 2021.

(51) Int. Cl. G01B 21/26; G01B 5/255

(52) U.S. Cl. CPC G01B 21/26; G01B 5/255

(57) ABSTRACT

A wheel measurement system includes a wheel position and orientation system (WPOS) that has a linear sensor configured to connect with a vehicle and extend between a body of the vehicle and a wheel of the vehicle to measure linear motion therebetween while the vehicle is in motion and two or more rotary sensors configured to monitor angular changes at a mounting position of the linear sensor at the body of the vehicle and a mounting position of the linear sensor at the wheel of the vehicle while the vehicle is in motion. The linear motion and the angular changes determine movements of the wheel relative to the body while the vehicle is in motion.

### CROSS REFERENCE TO RELATED APPLICATION(S)

This application claims priority to and the benefit of U.S. Provisional Patent Application No. 63/194,423, filed May 28, 2021, which is incorporated herein in its entirety by reference.

### TECHNICAL FIELD

This disclosure relates to a wheel measurement system and more particularly to a wheel positioning and orientation system (WPOS) capable of measuring up to five degrees of freedom of a wheel relative to a vehicle body (e.g., within a vehicle wheel well).

### BACKGROUND

Rotary sensors have been used to measure rotation of a vehicle wheel around more than one axis. These rotary sensors such as a rotary encoder can accurately measure an amount of movement of a vehicle wheel about an axis during testing of a vehicle. These rotary sensors are in communication with a controller that is part of a measuring device so that a position of a wheel may be ascertained.

### SUMMARY

While current measuring devices can accurately measure rotation of a vehicle wheel using rotary sensors, it would be desirable to have a system that additionally measures a position of a wheel relative to a body of the vehicle. A robust system that may measure wheel positions during durability testing (e.g., riding on a rough road or off road) is desirable. It would also be desirable to have a compact system (e.g., a system that fits entirely on a side of a vehicle and/or does not extend over a hood of the vehicle). It would be desirable for the system to be usable with other systems capable of measuring three forces and three moments generated on the wheel of a vehicle.

The present teachings provide a wheel measurement system that includes a WPOS. The WPOS can include a linear sensor configured to connect with a vehicle and extend between a body of the vehicle and a wheel of the vehicle to measure linear motion therebetween while the vehicle is in motion and two or more rotary sensors configured to monitor angular changes at a mounting position of the linear sensor at the body of the vehicle and a mounting position of the linear sensor at the wheel of the vehicle while the vehicle is in motion. The linear motion and the angular changes determine movements of the wheel relative to the body while the vehicle is in motion.

In some implementations, the two or more rotary sensors are three or more rotary sensors. In some implementations, the two or more rotary sensors are four or more rotary sensors.

In some implementations, the measured values of the linear sensor and the two or more rotary sensors may be used to determine a camber angle and a steering angle of the wheel.

In some implementations, the linear sensor has a length and an axis extends through the length of the linear sensor, and the linear sensor measures movements of the wheel relative to the body along the axis.

In some implementations, the linear sensor in combination with the two or more rotary sensors measures a distance of movement between the body and the wheel.

In some implementations, the linear sensor includes a first end and a second end and the first end, the second end, or both include a ball joint.

In some implementations, the linear sensor measures from a center of the wheel and a fender of the body.

In some implementations, the WPOS includes one or more guide shafts that extend between the body and the wheel of the vehicle and support the linear sensor. In some implementations, the one or more guide shafts carry a load when the wheel moves relative to the body so that the linear sensor axially moves without carrying a load.

In some implementations, the WPOS includes a vehicle mount configured to connect an upper portion of the WPOS to the body and a lower portion of the WPOS to the wheel.

In some implementations, the body includes a fender and the vehicle mount is configured to connect to the fender of the vehicle.

In some implementations, the vehicle mount is configured to form a connection that is sufficiently strong to bias one or more guide shafts, the linear sensor, or both and to be removable from the vehicle without damaging the vehicle.

In some implementations, the wheel measurement system includes a stator angle correction device connected to the body of the vehicle adjacent to the WPOS and a wheel force transducer system connected to the wheel adjacent to the WPOS.

In some implementations, the wheel measurement system includes a controller, one or more printed circuit boards, or both.

The system described herein is compact and measures a position of the wheel relative to the body of the vehicle, while being capable of working with wheel force transducers and other wheel measurement devices.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a perspective view of a wheel measurement system connected to a vehicle.

FIG. 1B is a perspective view of a wheel measurement system of FIG. 1A.

FIG. 1C is a perspective view of a measurement system of FIG. 1A with rotary sensors exposed.

FIG. 2 is a perspective view of a rotary sensor of the teachings herein.

FIG. 3 is an exploded view of a guide shaft.

FIG. 4 is an exploded view of a linear sensor.

FIG. 5 is a perspective view of a stator angle correction device (SACD) included in the wheel measurement system of FIG. 1A.

FIG. 6 is a side view of the wheel showing the connection of the WPOS at the wheel and the distances used to determine the wheel position and orientation.

### DETAILED DESCRIPTION

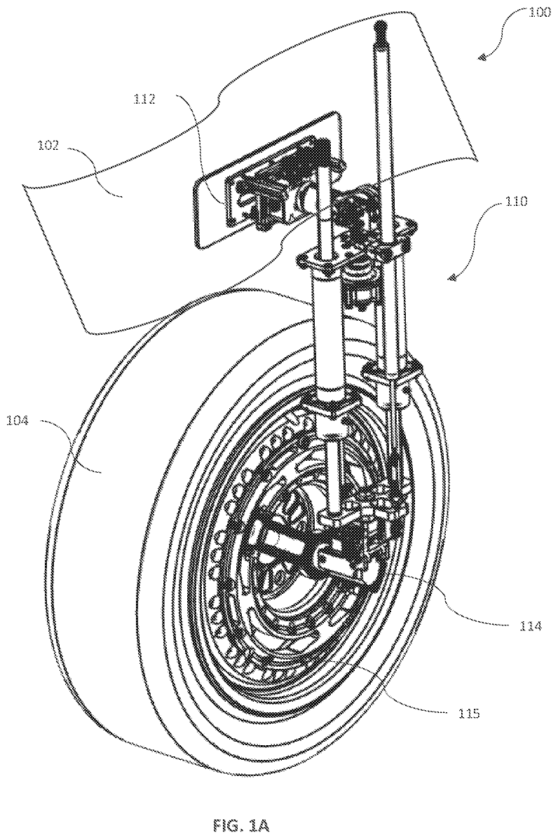

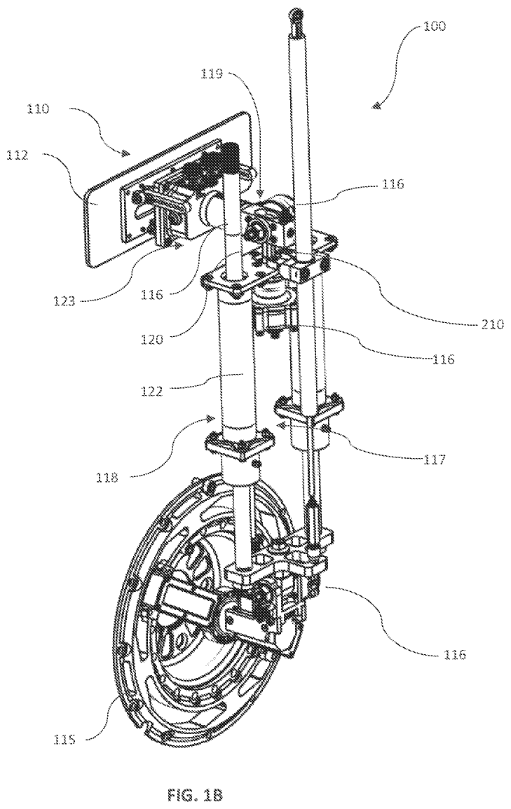

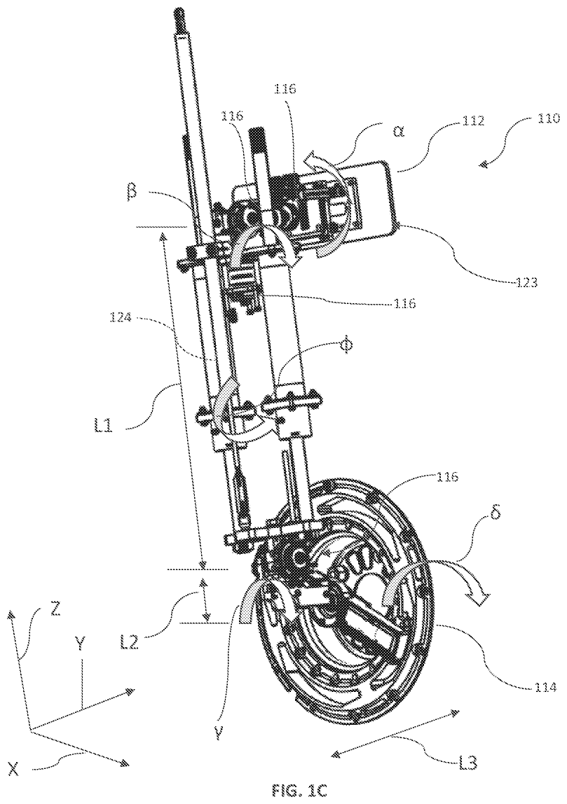

FIG. 1A is a perspective view of a vehicle 100 having a fender 102 and a wheel 104. The fender 102 is part of a body of the vehicle 100. The fender 102 is located entirely on a side of the vehicle 100 and stops before the fender 102 reaches a hood of the vehicle 100. The fender 102 and the wheel 104 are coplanar as shown. Fenders may be found in various shapes and arrangements in relation to a wheel, so this arrangement is shown only as an example. The wheel 104 is movable relative to the body and the fender 102. For example, when a vehicle 100 hits a bump or pothole the shocks of the vehicle permit the wheel 104 to move such that the amount of movement recognized by the fender 102 and felt by occupants is minimized. The present teachings provide a wheel measurement system that includes a wheel position and orientation system (WPOS) 110. The WPOS 110 is configured to connect to a vehicle and measure the movements of the wheel 104 relative to the fender 102 or to another portion of the body of the vehicle (e.g., above the wheel 104).

The WPOS 110 is connected to the vehicle 100. The WPOS 110 includes a vehicle mount 112 connected to a side (e.g., the fender 102) of the vehicle 100 and a wheel mount 114 connected to a wheel 104 of the vehicle 100. The vehicle mount 112 is free of any extension over a top of the vehicle (e.g., hood). The vehicle mount 112 and the wheel mount 114 may be coplanar when the WPOS 110 is in a connected state or configuration, but this is not required. The vehicle mount 112 may connect to the vehicle 100 via any fastening device. The vehicle mount 112 may be permanently connected (e.g., an adhesive, screw, welding). The vehicle mount 112 may be removably connected or configured to connect and be removed (e.g., a magnet, temporary adhesive, suction cups). The vehicle mount 112 may connect without damaging the vehicle 100 and the fender 102. The vehicle mount 112 may attach in a different manner than the wheel mount 114.

The wheel mount 114 may connect to a tire, a rim, or both of a vehicle 100. The wheel mount 114 may connect to lugs or lug nuts of the wheel 104. The vehicle mount 112 may maintain the WPOS 110 static during testing. The wheel mount 114 may move with the wheel 104 so that movement of the wheel 104 in one or more, two or more, three or more, four or more, five or more, or even six or more degrees may be measured. The wheel mount 114 may move within a coordinate system within and about an X-axis, a Y-axis, a Z-axis, or a combination thereof. The wheel mount 114 may be movable relative to the vehicle mount 112, and the vehicle mount 112 may be static so that movement of the wheel 104 may be measured relative to the fender 102 (e.g., body) of the vehicle 100. For example, the wheel 104 may rotate about a rotational axis and the wheel may pivot about a plane that is perpendicular to the rotational axis. In the example shown, the wheel mount 114 is mounted at an end of a slip ring that is a portion of a force or torque measuring device 115 including wheel force transducers and/or wheel torque transducers mounted on the wheel 104. By so mounting the WPOS 110, the wheel measurement system can provide measurements of forces and moments experienced by the wheel 104 in addition to those measurements of wheel position and orientation made by the WPOS 110. The device 115 may be, for example, a wheel force transducer available from Michigan Scientific Corporation of Milford, MI, such as the Model LW60 wheel force transducer. The device 115 may be omitted from the wheel measurement system in other implementations. In such implementations, the WPOS 110 may be mounted on a slip ring.

FIG. 1B illustrates a perspective view of the WPOS 110. The WPOS 110 includes the vehicle mount 112 at the top and the wheel mount 114 at a bottom with rotary sensors 116 located therebetween. As shown, four rotary sensors 116 are present. The rotary sensors 116 are connected between the vehicle mount 112 and the wheel mount 114 by guide shafts 118. Each of the rotary sensors 116 measures a different angular change that together with the linear sensor 124 may be used to determine steering angle and camber angle, for example. The rotary sensors 116 may measure around a rotational axis, rotation within an axis, or both. The one or more guide shafts 118 may extend between the vehicle mount 112 and the wheel mount 114 to connect the WPOS 110 to a vehicle 100 while allowing movement of the WPOS 110 that may be measured by the rotary sensors 116.

The guide shafts 118 function to allow the vehicle mount 112 to move relative to the wheel mount 114 or vice versa. The guide shafts 118 are supported by (e.g., hang from) the vehicle mount 112 and associated componentry. As shown, the guide shafts 118 include a shaft 120 surrounded by a guide tube 122. The guide tube 122 may be moved along the shaft 120 or vice versa so that at least a portion of the WPOS 110 is movable (e.g., floats) between the wheel 104 and the fender 102 or other body part on which the vehicle mount 112 is affixed. The shaft 120 may be static. The shaft 120 is surrounded by the guide tube 122, which may movably slide along the shaft 120. The guide tube 122 may carry componentry (e.g., sensors) axially between the vehicle mount 112 and the wheel mount 114. The guide tubes 122 may include bias devices (e.g., springs). The bias device biases the guide tube 122 along the shaft 120. The guide shaft 118 may be free of any bias devices. The WPOS 110 may include one guide shaft 118 or two guide shafts 118. The guide tubes 122 may extend parallel to or include linear sensors 124. The guide tubes 122 support the linear sensors 124 while allowing the linear sensors 124 to axially translate.

The linear sensors 124 may be connected at an upper end proximate to the vehicle mount 112 and a lower end proximate to the wheel mount 114. The linear sensor 124 may be movable along an axis that extends through a length of the linear sensor 124. The linear sensor 124 may be movable up and down. The linear sensor 124 may include a pivot (e.g., a ball joint 140 discussed below) at an end (e.g., lower end or upper end) such that the linear sensor 124 remains straight regardless of a position of the wheel 104 that the linear sensor 124 is monitoring. More specifically, the pivot allows the axis of the linear sensor 124 to not be parallel to the axis of the shaft 120 by preventing stresses from developing due to the axes not being parallel. The linear sensor 124 may measure movement between the fender 102 and wheel 104. For example, if the wheel 104 hits a bump or a pothole the wheel 104 may be moved towards the fender 102, at least temporarily, linearly moving the linear sensor 124. The linear sensor 124 and the rotary sensors 116 work in concert to determine how the wheel 104 moved relative to the body (such as fender 102), the ground, or both. The WPOS 110 can be used to transform forces and moments obtained from the optional wheel force transducer. More specifically, forces and moments measured by the device 115 (e.g., a wheel force transducer) along with the SACD 123 are determined in the wheel planes. By transforming the forces and moments to vehicle body coordinates, an improvement in operations of steered front wheels can result.

FIG. 1C illustrates rotational movements, linear movements, moments, or a combination thereof that are monitored and measured by the wheel measurement system including the WPOS 110. In brief, the WPOS 110 can have four rotating joints and one or more translating joints for a total of five degrees of freedom. The WPOS 110 can measure these five degrees of freedom and, using coordinate transformation matrix math and trigonometry, determine the X-axis, Y-axis, and Z-axis positions of the wheel 104, along with the wheel camber and steer angle of the wheel relative to a set zero position.

In more detail, the WPOS 110 includes four of the rotary sensors 116 and one of the linear sensors 124. The rotary sensors 116 and the linear sensor 124 may be in electrical communication, in communication with a controller, or both. An upper portion of the WPOS 110 includes the vehicle mount 112 to which a stator angle correction device (SACD) 123 may also be coupled to form part of the wheel measurement system. In some implementations, the SACD 123 may be a stator angle correction device described in U.S. Patent Publication No. 2021/0278318 A1.

A first of the rotary sensors 116 is located between the vehicle mount 112 and the linear sensor 124 to measure an angle of movement α. The angle α measures angular movements of the wheel mount 114 relative to the vehicle mount 112 and optionally the SACD 123. A second rotary sensor 116 is located between the first rotary sensor 116 and the linear sensor 124. The second rotary sensor 116 measures an angle of movement β. The angle of movement ß is an amount of movement of the wheel mount 114 outward relative to the vehicle mount 112 about a joint 119. The joint 119 shown has two rotational axes that are not centered at the same intersecting point, like would be seen in a U-joint, but the joint 119 provides similar degrees of freedom as a U-joint and could be replaced by a U-joint.

A third rotary sensor 116 is located between the second wheel sensor 116 and the linear sensor 124. The third rotary sensor 116 measures an angle of movement ¢. The angle of movement ϕ (e.g., rotation about an axis) is an angle of rotation about a midpoint 117 between the shafts 120 and hence the guide tubes 122. A fourth rotary sensor 116 is located between the linear sensor 124 and the wheel mount 114. The fourth rotary sensor 116 measures an angle of movement δ, which is an angle on an axis parallel to the actual camber angle of the wheel 104, where the camber angle is an angle of the wheel plane relative to a plane perpendicular to the ground. The angle of movement γ is a rotation of the wheel about a rotational axis of the vehicle wheel, which may be measured by an encoder in the slip ring of the wheel 104. It is not needed by the controller of the WPOS 110 for the determination of any of the wheel steering angle, the camber angle, the X-axis position, the Y-axis position, or the Z-axis position, but it may be available for other applications.

FIG. 1C illustrates a coordinate system include a Z-axis, a Y-axis, and an X-axis. Distances L1 and L2 extend along the Z-axis and L3 extends along the Y-axis as described below. Angle α reflects rotation about the Y-axis. Angle β reflects rotation about the X-axis. Angle ϕ reflects rotation around the Z-axis. Angle δ reflects rotations about the Z-axis. Angle γ reflects rotation around the Y-axis. The angle δ relates to the camber angle, which is associated with a distance L3. Specifically, the angle δ is on an axis parallel to the actual camber angle of the wheel 104. It is worth noting that as the wheel moves, the axis about which rotation is measured by each rotary sensor 116 may also move.

Despite specific angles and axes being shown and referenced for each of the rotary sensors 116, each of the rotary sensors 116 may be used to monitor different angles. However, each rotary sensor 116 may be used to measure at least one of the angles listed herein or is used to measure a portion of the angles or movements listed herein. For example, one rotary sensor 116 may measure movement within one plane and a second rotary sensor 116 may measure movement within a second plane and the combination of the two measurements may provide a complete measurement of the movement. The rotary sensors 116 may be in communication with a controller, another of the rotary sensors 116, and/or the linear sensors 124 so that a combination of the rotary sensors 116, the linear sensor 124, the controller, or a combination thereof may be used to monitor each, some, or all of the angles, linear movements, moments, or a combination thereof discussed herein used to determine, e.g., X-distance, Y-distance, Z-distance, camber angle, steer angle.

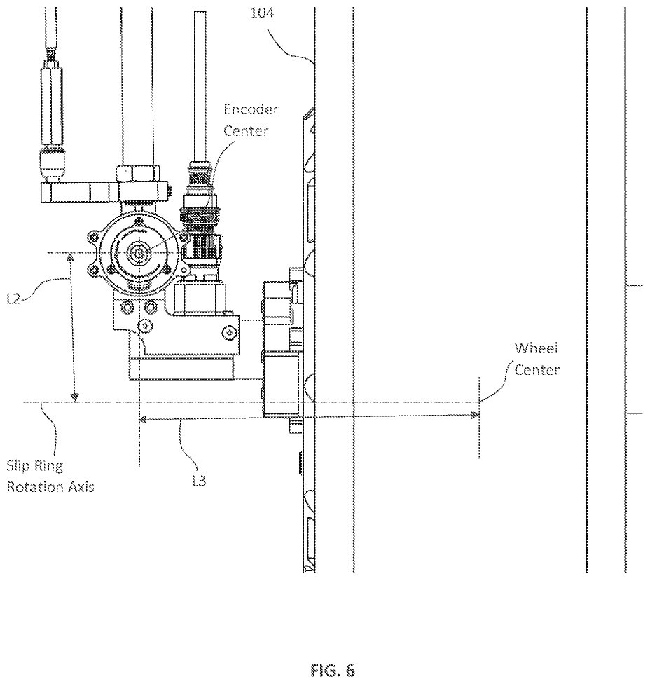

The distance L1 is determined at a starting position (e.g., where L1 extends to the plane that contains the rotational axes for angles α and β). Measurements from the linear sensor 124 are differentials to determine new values for the movement distance L1 when the wheel mount 114 moves relative to the vehicle mount 112. For example, if the wheel 104 of FIG. 1A moves towards the fender 102 or vice versa, the linear sensor 124 measures the movement distance L1. The distance L2 and the distance L3 are fixed values that may be input into the system for use in the calculations described herein. FIG. 6 is a side view of the wheel showing the connection of the WPOS 110 at the wheel 104 and the distances L2, L3 used to determine the wheel position and orientation. As can be seen from FIG. 6, the distance L2 is the distance between the rotational axis of the slip ring on which the WPOS 110 is supported at the wheel 104 and the center (e.g., of a rotational axis) of the rotary sensor 116 (e.g., an encoder), and the distance L3 is the distance between the center of the wheel 104 (i.e., the center of the wheel along the axial direction) and the center of the rotary sensor 116. These distances may be measured with calipers, rulers, etc., for use by the controller of the WPOS 110.

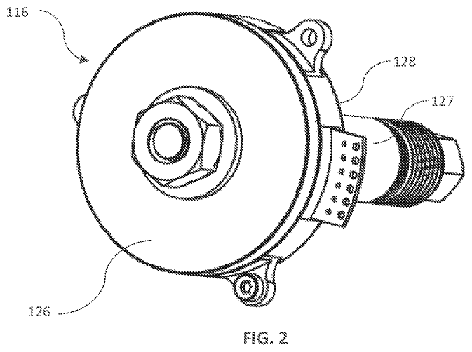

FIG. 2 is a perspective view of a rotary sensor 116 that includes a rotor 126 and a stator 128. The rotor 126 is a rotating portion that rotates about a shaft 127 with movement of the wheel 104. The stator 128, which is a non-rotating, or stationary portion, is fixed to the WPOS 110 or, as will be described, to a stator angle correction device. The rotary sensor 116 may be a rotary encoder or other device that measures precise rotation of one vehicle component relative to another vehicle component. The rotary sensor 116 may include a high-resolution rotary position encoder, or other suitable device. The rotary sensor 116 may be disposed on an outer portion of the load transducer such that the rotary sensor 116, or a rotor 126 associated with the rotary sensor 116, rotates with the load transducer and the wheel 104. The stator 128 can be attached to one or more fixtures. The stator 128 and attached fixtures will be referred to as stator 128. A first portion of the stator 128 may be rigidly coupled or attached to a portion of the wheel 104 via the WPOS 110, the rotary sensor 116, or the load transducer using, for example, a bracket that allows a position of the stator 128 to remain substantially stationary while the wheel 104, and consequently, the load transducer and the rotary sensor 116 (e.g., the rotor 126), rotate. A second portion of the stator 128 may be coupled or attached to a portion of a vehicle 100 by the WPOS 110, such as a portion of the body (e.g., the fender 102) of the vehicle 100. The stator 128 may be coupled or attached to the wheel mount 114 that extends from the wheel 104 and rigidly mounts to a steering knuckle or other part of a suspension of the vehicle 100. Each of the rotary sensors 116 may be connected within the WPOS 110 and a portion of the WPOS 110 that may move the rotor 126 and hold the stator 128 such that (e.g., rotational) movement of a wheel 104 relative to a fender 102 may be measured.

The rotary sensor 116 is adapted to rotate with the rotation of the wheel 104 or some movable component of the vehicle. The rotary sensor 116 may include one or more sensors. The one or more sensors may include rotational position sensors or other suitable sensors. At least one of the one or more sensors may be adapted to measure a rotational position between the at least one sensor and the stator 128. For example, as the wheel 104, and consequently, the rotary sensor 116 or a rotor 126 associated with the rotary sensor 116, rotates, the at least one sensor passes the stationary position of the stator 128. The at least one sensor is adapted to measure a current position of the at least one sensor relative to the stator 128. The rotary sensor 116 is adapted to generate an analog or digital signal corresponding to the measured current position. The rotary sensor 116 communicates the signal corresponding to the current position to a controller that may be remote from the wheel measurement device or may be mounted in, for example, the vehicle mount 112 for wireless or wired communication to another external controller (not shown). The at least one sensor is adapted to continuously measure positions of the at least one sensor relative to the stator 128. The rotary sensor 116 may communicate signals corresponding to respective current positions on demand, continuously or at other suitable periods to the controller.

The rotary sensors 116 may be adapted to directly measure one or more rotational positions of the wheel 104 using the respective positions of the stators 128. The rotary sensors generate signals corresponding to respective rotational positions of the wheel 104. The rotary sensors 116 may work together or may each measure one rotational component so that a complex geometry within a coordinate system may be measured, calculated, output, or a combination thereof. For example, if the wheel rotates about the X-axis, moves up and down along the Z-axis, while moving back and forth about the X-axis, two or three different sensors (e.g., rotary sensors and/or linear sensors) may have measurement data that may be compared by the controller to calculate, measure, or output movements along or relative to each of these axes within the coordinate system. The rotary sensor 116 may communicate the signals to the controller.

The WPOS 110 may include the described controller. The controller may be any suitable computing device that includes a processor, memory, and/or other suitable computing components, and may include a user interface where the controller is remotely located. The controller is configured to receive, as described, the signals corresponding to the one or more measured forces or loads acting on the wheel 104 from the load transducer, the rotary sensors 116, the linear sensors 124, or a combination thereof of the signals corresponding to measured positions of the rotor relative to the stator 128, the signals corresponding to respective timestamps from the rotary sensor 116, other suitable signals, or a combination thereof. The load transducer and the rotary sensor 116 may communicate signals to the controller using any suitable technique. For example, the WPOS 110 may include one or more communications cables (not shown) connected to the load transducer, the rotary sensor 116, or both and to the controller such that signals and other data may be passed from the load transducer and the rotary sensor 116 to the user interface controller.

The controller is adapted to determine one or more rotary positions of the wheel 104 and/or other suitable characteristics of the wheel 104 based on the signals corresponding to the current positions of a rotary encoder (e.g., the rotor 126) relative to an encoder stator (e.g., the stator 128) and the signals corresponding to the respective timestamps. Additionally, or alternatively, the user interface controller is adapted to perform coordinate transformation on the forces or loads acting on the wheel 104 based on the signals received from the load transducer. For example, the user interface controller receives signals corresponding to the three primary forces acting on the wheel 104 and signals corresponding to the three moments corresponding to the three primary forces, as described below. In some embodiments, the user interface controller receives signals corresponding to the rotational positions of the wheel 104.

The controller performs coordinate transformation to organize the forces acting on the wheel 104 in the X-axis, Y-axis, and Z-axis coordinate system, which may be referred to as a vehicle coordinate system, as is generally illustrated in FIG. 1C. The controller may combine readings from each of the rotary sensors 116, linear sensor 124, or both to provide a complete picture or complete measurement of all of the movements, moments, forces, or a combination thereof made in all of the various planes. The vehicle coordinate system may include a force along the Y-axis and a corresponding moment about the Y-axis, a force along the X-axis and a corresponding moment about the X-axis, and a force along the Z-axis and a corresponding moment about the Z-axis.

The user interface controller may communicate the vehicle coordinate system, values associated with the forces and moments acting on the wheel 104, values associated with the one or more rotary wheel positions associated with the wheel 104, one or more wheel speeds of the wheel 104, movement between the body (e.g., the fender 102) and the wheel 104, other characteristics of the wheel 104, or a combination thereof to a data recorder (not shown). Where present, a user interface may be implemented by a computing device, such as a laptop computer, a desktop computer, a mobile computing device (e.g., a smartphone or tablet), other suitable computing device, or a combination thereof. The WPOS 110 is adapted to allow a user to review and analyze forces and moments acting on the wheel 104. The analysis of the forces and moments acting on the wheel 104 may be used to analyze durability of various components of the vehicle 100. The analysis of the forces and movements may be reviewed or output in real time.

As described, the controller may use the adjusted wheel rotational positions to perform the coordinate transformation. The user interface controller may communicate forces, moments, wheel speeds, the adjusted rotational positions, and the adjusted vehicle coordinate system resulting from the coordinate transformation to a data recorder.

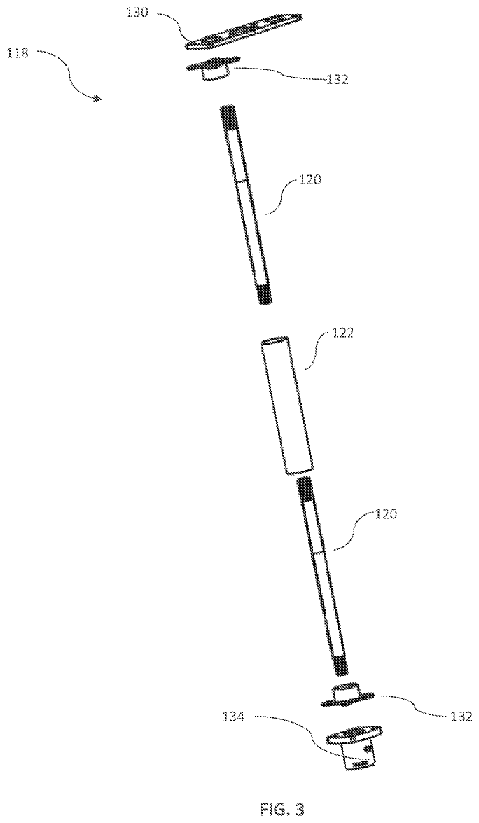

FIG. 3 is an exploded view of a guide shaft 118 that may be used in the wheel measurement system of FIGS. 1A-1C. The guide shaft 118 as shown has a multi part shaft 120, but the shaft 120 may be a single shaft. The shaft is covered by a guide tube 122 that is movable along the shaft 120. A top of the guide shaft 118 is connected to a guide shaft brace 130. The guide shaft brace 130 may align two or more guide shafts 118 relative to one another, in a parallel relationship, or both. The guide shaft brace 130 may connect the guide shaft 118 to the vehicle mount 112, the SACD 123, or both. The guide shaft brace 130 may connect and/or orient a linear sensor 124 relative to the guide shaft 118. The guide shaft brace 130 may be a static component and the shaft 120, guide tube 122, or both may move relative to the guide shaft brace 130. The guide shaft brace 130 may be in communication with a tube adapter 132. A tube adapter 132 may be located at the top of the guide tube 122 and the bottom of the guide tube 122.

The tube adapter 132 functions to support the guide tube 122 while allowing movement of the shaft 120 and the guide tube 122 relative to one another. The tube adapter 132 may connect the guide tube 122 to the guide shaft brace 130 so that the guide tube 122 is fixed. The tube adapter 132 may fit within an inside of the guide tube 122 and around an outside of the shaft 120 so that the guide tube 122 and shaft 120 are movably connected to one another. The tube adapter 132 may maintain the shaft 120 and guide tube 122 in a co-axial relationship. The shaft 120 may move within the guide tube 122, the tube adapter 132, or both so that translation of the WPOS 110 along an axis of the guide shaft 118 is permitted. The shaft 120 may be sufficiently long so that the shaft 120 extends within the guide tube 122, within the tube adapters 132, through the guide tube 122, through the tube adapters 132, or a combination thereof. The tube adapters 132 may maintain the guide tube 122 in a static position and allow the shaft 120 to translate within the guide tube 122. One or more bias devices may be located within the guide tube 122 to bias the shaft 120 relative to the guide tube 122. The guide shaft 118 may be free of bias devices (e.g., springs), and the movement of the shaft 120 relative to the guide tube 122 may be controlled based upon movement of the wheel 104 relative to the fender 102. The tube adapters 132 may be sandwiched between the guide shaft brace 130 and the linear sleeve bearing 134.

The linear sleeve bearings 134 may function to permit movement of the shaft 120 axially (linearly) relative to the guide tube 122 or vice versa. The linear sleeve bearings 134 may allow for linear movement only of the shaft 120 relative to the guide tube 122 or vice versa. The linear sleeve bearing may only allow the shaft 120, guide tube 122, or both to move a predetermined distance. The linear sleeve bearing 134 may maintain the shaft 120 and the guide tube 122 co-axial with one another. The linear sleeve bearing 134 allows the shaft 120 to translate a distance that is greater than a distance the wheel 104 moves relative to the fender 102. The linear sleeve bearing 134 may permit movement of the guide shaft 118 a distance that is equal to or greater than a distance the linear sensor 124 may need to move, to measure movement of the fender 102, relative to the wheel 104 or vice versa.

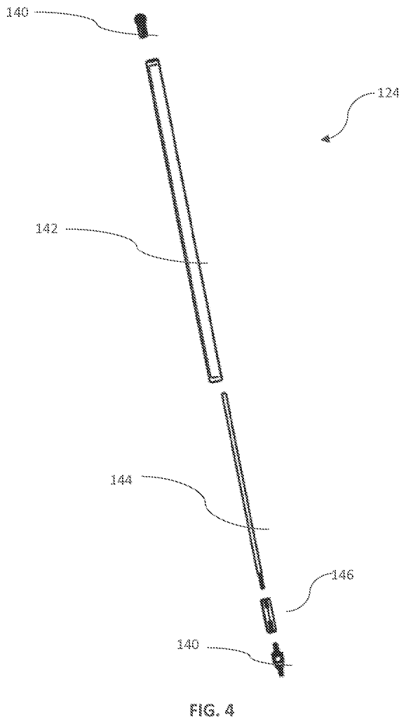

FIG. 4 is an exploded perspective view of the linear sensor 124. The linear sensor 124 measures a linearly moved distance (e.g., an amount of travel along a line). The linear sensor 124 has a first end and a second end that are fixed with a central portion that is movable. The first end and the second end are movable relative to one another, but fixed relative to components of the vehicle. The central portion (e.g., a linear potentiometer 142 and a translating shaft 144) is movable to accommodate for distance changes of the vehicle. The linear sensor 124 may measure an absolute length (e.g., if a component of the vehicle changes planes but an axial distance of the linear sensor 124 remains constant no length will be recorded). The linear sensor 124 may measure a distance change between a first end and a second end that is provided by the central portion moving.

The linear sensor 124 includes ball joints 140 at the first end and the second end. The linear sensor 124 may only include a ball joint 140 at a first end or a second end. The ball joints 140 function is to maintain the linear sensor 124 positioned along an axis or parallel to an axis when components of a vehicle move in and out of planes, change position, or both. The ball joints 140 may include a ball that is movable within a socket. The ball joints 140 may allow for movement in virtually any direction. The ball joints 140 may maintain a connection at the first end, at the second end, or both. The ball joints 140 may remove stresses put on the linear sensor 124 during testing. The ball joints 140 may allow the linear potentiometer 142 and the translating shaft 144 to move relative to one another without binding, becoming damaged, being tied up, or a combination thereof.

The linear potentiometer 142 may linearly move along the translating shaft 144 or vice versa so that a linear distance (e.g., a distance along an axis or length of the linear sensor 124) may be measured. The linear potentiometer 142 may electrically measure, physically measure, or both a distance moved. The linear potentiometer 142 may include a wheel that rotates as the linear potentiometer 142 and translating shaft 144 are moved relative to one another. The linear potentiometer 142 may measure a change in resistance as the linear potentiometer 142 and translating shaft 144 move relative to one another. For example, an electrode may be located at a first end of the translating shaft 144 or the linear potentiometer 142 and a second electrode may be located at a second end of the translating shaft 144 or the linear potentiometer 142 and as the linear potentiometer 142 and the translating shaft 144 move relative to one another the distance may vary and thus the resistance may vary. Based upon the change in resistance the distance traveled may be measured, determined, calculated, or a combination thereof. The linear potentiometer 142 may contact the translating shaft 144 and as the translating shaft 144 moves with the linear potentiometer 142, an amount of resistance measured by the linear potentiometer 142 may vary. The variation in resistance may be directly or proportionally correlated to a distance traveled.

The translating shaft 144 may be movable and the linear potentiometer 142 may be static or vice versa. The translating shaft 144 may be in contact with brushes that extend from the linear potentiometer 142 to the translating shaft 144. The linear potentiometer 142 may be fixed at a first end and the translating shaft 144 may be fixed at a second end and the first end of the translating shaft 144 may move relative to the second end of the linear potentiometer 142. The translating shaft 144 is configured to extend into the linear potentiometer 142 and to move within the linear potentiometer 142 so that a distance may be measured. The translating shaft 144 may conduct electricity so that a resistance change in the translating shaft 144 may be monitored as the translating shaft 144 moves. The translating shaft 144 may be solid, hollow, steel, aluminum, iron, made of metal, made of plastic, or a combination thereof. The translating shaft 144 may be connected to an adapter 146.

The adapter 146 adapts a linear sensor rod (e.g., the shaft 144) to a ball joint 140. As briefly mentioned above, the ball joint 140 bolts to the plate that the tubes 122 bolt to at the bottom of the WPOS 110.

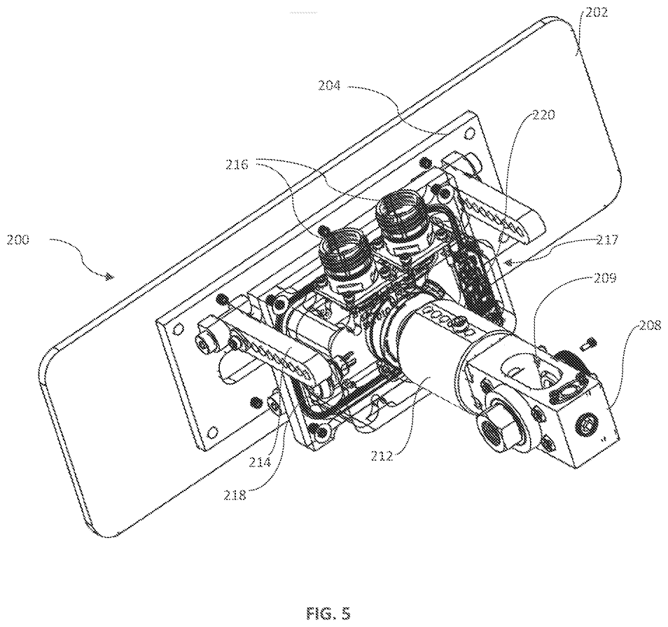

In some embodiments, the WPOS 110 may be used with a wheel force transducer SACD 123, where a further example is provided in FIG. 5 as SACD 200. The SACD 200 may be referred to as a SAC device, a SAC apparatus, or a SAC module. The SACD 200 is adapted to measure an angle of the encoder sensor 116 during operation. In this way, the SACD 200 measures the angle α, eliminating the need for a separate rotary sensor 116 for this measurement by the WPOS 110. In other words, the measurement of the angle α for the WPOS 110 may be performed by the SACD 200. The SACD 200 may also intercept the signals corresponding to the forces and moments communicated by the load transducer (e.g., from device 115), the other rotary sensors 116 and the linear sensor 124 of the WPOS 110, or a combination thereof before the signals reach a user interface controller. The controller of the SACD 200 may determine the wheel position and orientation, instead of having a separate controller for the WPOS 110.

FIG. 5 is a perspective view generally illustrating the SACD 200. The SACD 200 includes a vehicle mount 202. The vehicle mount 202 is adapted to rigidly connect or attach the SACD 200 to a portion of the vehicle 100. For example, the vehicle mount 202 is adapted to rigidly attach the SACD 200 to a fender 102 of the vehicle 100. The vehicle mount 202 may connect or attach the SACD 200 using any suitable technique. For example, the vehicle mount 202 may include a temporary or permanent adhesive that engages the portion of the vehicle 100 and rigidly connects or attaches the SACD 200 to the portion of the vehicle 100. In some embodiments, the vehicle mount 202 may be mechanically secured to the portion of the vehicle 100. For example, the vehicle mount 202 may be riveted, screwed, bolted, or otherwise mechanically secured to the portion of the vehicle 100 using other suitable techniques. In some embodiments, the vehicle mount 202 may comprise a magnet or magnetic material adapted to secure the SACD 200 to the vehicle using magnetic forces.

The SACD 200 includes a mounting bracket 204. The mounting bracket 204 is adapted to rigidly mount components of the SACD 200 to the vehicle mount 202 using any suitable technique. For example, the mounting bracket 204 may be mechanically secured to the vehicle mount 202 as described above.

The SACD 200 includes a rod retainer 208. The rod retainer 208 is adapted to receive a portion of a rod 210, as is generally illustrated in FIG. 1B. A first portion of the rod 210 is adapted to be rigidly connected or attached to a portion of the rotary sensor 116. A second portion of the rod 210 is adapted to be received in a through-bore 209 of the rod retainer 208. The rod retainer 208 may include a locking mechanism (not shown) disposed within the through-bore 209. The locking mechanism may be adapted to limit or control movement of the rod 210 in the through-bore 209. During operation, the first portion of the rod 210 remains rigidly connected or attached to the rotary sensor 116 and the second portion of the rod 210 moves substantially freely through the through-bore 209 of the rod retainer 208. For example, when the wheel 104 is steered, the first portion of the rod 210 moves with the rotary sensor 116. The rod 210 has a fixed length.

The SACD 200 includes a telescoping adapter 212 that extends between a housing of the SACD 200 and the rod retainer 208. The telescoping adapter 212 functions to permit adjustment of the SACD 200 housing relative to the rod retainer 208 so that the WPOS 110 may be adapted for different vehicles 100. As the telescoping adapter 212 is adjusted, an adjustable bracket 214 may be adjusted to retain a position or to lock the WPOS 110 in the adjusted position. The adjustable bracket 214 may be pinned in place, mechanically fastened, locked, or a combination thereof.

The SACD 200 includes a controller 217 located on or in communication with a printed circuit board 220 located within the SACD 200. The SACD 200 may include two or more or even three or more printed circuit boards 220. The controller 217 may be located on one of the printed circuit boards 220. The controller 217 may include any suitable controller, as described herein. The controller 217 may intercept the signals corresponding to the forces and moments acting on the wheel 104 from the rotary sensor 116, the linear sensor 124, or both. The controller 217 may then adjust the wheel rotational position signals while not modifying the force and moment signals. For example, the SACD 200 includes one or more communications ports 216. A communications cable, as described, may connect one of the communications ports 216 to the rotary sensor 116, the linear sensor 124, or both. The controller 217 may adjust the values of the wheel rotation position signals based upon a stator angle. The controller 217 generates signals corresponding to the adjusted wheel rotational position of the wheel 104. The controller 217 communicates the signals to the second (e.g., user interface) controller, as described above. A communications cable may connect another of the communications ports 216 to the user interface controller. The controller 217 may generate a signal corresponding to the measured stator angle. The controller 217 communicates the measured signal to the user interface controller. The user interface controller may be adapted to adjust the force values and the moment values using the measured stator angle corresponding to the signal communicated by the controller 217.

The SACD 200 includes a relative position mechanism 218. The relative position mechanism 218 may include a button or other actuating device for activating the relative position mechanism 218 such that the WPOS 110 is centered within a coordinate system upon activation of the relative position mechanism 218 (e.g., the coordinates are all zeroed).

As described, the user interface controller may use the adjusted wheel rotational positions to perform the coordinate transformation. The user interface controller may communicate forces, moments, the adjusted rotational positions, and the adjusted vehicle coordinate system resulting from the coordinate transformation to a data recorder.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this disclosure, the term “or” is intended to mean an inclusive “or” rather than an exclusive “or” for the two or more elements it conjoins. That is, unless specified otherwise or clearly indicated otherwise by the context, “X includes A or B” is intended to mean any of the natural inclusive permutations thereof. In other words, if X includes A; X includes B; or X includes both A and B, then “X includes A or B” is satisfied under any of the foregoing instances. The term “and/or” as used in this disclosure is intended to mean an “and” or an inclusive “or.” That is, unless specified otherwise or clearly indicated otherwise by the context, “X includes A, B, and/or C” is intended to mean that X can include any combinations of A, B, and C. In other words, if X includes A; X includes B; X includes C; X includes both A and B; X includes both B and C; X includes both A and C; or X includes all of A, B, and C, then “X includes A and/or B” is satisfied under any of the foregoing instances. Similarly, “X includes at least one of A, B, and C” is intended to be used as an equivalent of “X includes A, B, and/or C.” In addition, the articles “a” and “an” as used in this application and the appended claims should generally be construed to mean “one or more” unless specified otherwise or clear from context to be directed to a singular form. Moreover, use of the term “an aspect” or “one aspect” throughout this disclosure is not intended to mean the same aspect or implementation unless described as such.

The use of “including” or “having” and variations thereof herein is meant to encompass the items listed thereafter and equivalents thereof as well as additional items. Unless specified or limited otherwise, the terms “mounted,” “connected,” “supported,” “coupled,” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the disclosure (especially in the context of the following claims) should be construed to cover both the singular and the plural. Furthermore, recitation of ranges of values herein is merely intended to serve as a shorthand method of referring individually to each separate value falling within the range, unless otherwise indicated herein, and each separate value is incorporated into the specification as if it were individually recited herein. Finally, the operations of all methods described herein are performable in any suitable order unless otherwise indicated herein or otherwise clearly contradicted by the context. The use of any and all examples, or exemplary language (e.g., “such as”) provided herein, is intended merely to better illuminate the disclosure and does not pose a limitation on the scope of the disclosure unless otherwise claimed.

It should be understood that although this disclosure uses terms such as first, second, third, etc., the disclosure should not be limited to these terms. These terms are used only to distinguish similar types of information from each other. For example, without departing from the scope of this disclosure, a first information can also be referred to as a second information; and similarly, a second information can also be referred to as a first information. Depending on the context, the word “if” as used herein can be interpreted as “when,” “while,” or “in response to.”

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation as is permitted under the law to encompass all such modifications and equivalent arrangements.

1. A wheel measurement system, comprising:
a wheel position and orientation system (WPOS) including:
a linear sensor configured to connect with a vehicle and extend between a body of the vehicle and a wheel of the vehicle to measure linear motion therebetween while the vehicle is in motion; and
two or more rotary sensors configured to monitor angular changes at a mounting position of the linear sensor at the body of the vehicle and a mounting position of the linear sensor at the wheel of the vehicle while the vehicle is in motion, wherein the linear motion and the angular changes determine movements of the wheel relative to the body while the vehicle is in motion.

2. The wheel measurement system of claim 1, wherein the two or more rotary sensors are three or more rotary sensors.

3. The wheel measurement system of claim 1, wherein the two or more rotary sensors are four or more rotary sensors.

4. The wheel measurement system of claim 1, wherein the movements comprise a steering angle, a camber angle, an X-axis position, a Y-axis position, and a Z-axis position of the wheel.

5. The wheel measurement system of claim 1, wherein the linear sensor has a length and an axis extends through the length of the linear sensor, and the linear sensor measures movement of the wheel relative to the body along the axis.

6. The wheel measurement system of claim 1, wherein the linear sensor in combination with the two or more rotary sensors measures a distance of movement between the body and the wheel.

7. The wheel measurement system of claim 1, wherein the linear sensor includes a first end and a second end and the first end, the second end, or both include a ball joint.

8. The wheel measurement system of claim 1, wherein the linear sensor measures from a center of the wheel and a fender of the body.

9. The wheel measurement system of claim 1, comprising:
one or more guide shafts that extend between the body and the wheel of the vehicle and support the linear sensor.

10. The wheel measurement system of claim 9, wherein the one or more guide shafts carry a load when the wheel moves relative to the body so that the linear sensor moves axially without carrying a load.

11. The wheel measurement system of claim 1, wherein the WPOS includes a vehicle mount configured to connect an upper portion of the WPOS to the body and a lower portion of the WPOS to the wheel.

12. The wheel measurement system of claim 11, wherein the body includes a fender and the vehicle mount is configured to connect to the fender of the vehicle.

13. The wheel measurement system of claim 11, wherein the vehicle mount is configured to form a connection that is sufficiently strong to bias one or more guide shafts, the linear sensor, or both and to be removable from the vehicle without damaging the vehicle.

14. The wheel measurement system of claim 1, comprising:
a stator angle correction device connected to the body of the vehicle adjacent to the WPOS and a wheel force transducer system connected to the wheel adjacent to the WPOS.

15. The wheel measurement system of claim 1, comprising:
a controller, one or more printed circuit boards, or both.

16. The wheel measurement system of claim 4, wherein the linear sensor has a length and an axis extends through the length of the linear sensor, and the linear sensor measures movement of the wheel relative to the body along the axis.

17. The wheel measurement system of claim 16, wherein the linear sensor in combination with the two or more rotary sensors measures a distance of movement between the body and the wheel.

18. The wheel measurement system of claim 17, wherein the linear sensor includes a first end and a second end and the first end, the second end, or both include a ball joint.

19. The wheel measurement system of claim 18, wherein the linear sensor measures from a center of the wheel and a fender of the body.

20. The wheel measurement system of claim 19, comprising:
one or more guide shafts that extend between the body and the wheel of the vehicle and support the linear sensor.
